(19) United States
(12) Patent Application Publication
(10) Pub. No.: US 2010/0209662 A1
(43) Pub. Date: Aug. 19, 2010

(54) WINE BOTTLE AND WINE GLASS HOLDER/SERVER/COASTER

(76) Inventors: Carol Lynn Slade, Cronulla (AU); Laura Lynn Mastro, Denver, CO (US); Olga Dunn Payne, Englewood, CO (US)

Correspondence Address: Carol Slade, 3169 South Detroit St., Denver, CO, 80210, US

(21) Appl. No.: 12/371,597

(22) Filed: Feb. 14, 2009

(51) Int. Cl. B32B 3/10

(52) U.S. Cl. 428/131

(57) ABSTRACT

The Wine Bottle and Wine Glass Holder/Server/Coaster is a wine or bottled beverage server, wine glass holder and a coaster once the wine is opened and poured. A central hole in the WB&WGH/S/C fits over the neck of the bottle and the top seal and surrounding this central hole are a number of receptacles where stemmed glasses are hung in an inverted position. This allows one person to carry and serve the wine and glasses WB&WGH/S/C by picking up the bottle and it can all be carried in one hand. Finally, once the beverage is opened the WB&WGH/S/C can be placed under the beverage bottle to act as a coaster and catch any drips.

### CROSS-REFERENCED TO RELATED APPLICATIONS

Cross-Referenced: Not Applicable

### FEDERALLY SPONSORED RESEARCH OR DEVELOPMENT

Federally Funder Research: Not Applicable

The wine glass and bottle holder/server is used to allow wine or any bottled beverage consumed from a wine glass or stemware, to be presented as a single package to be served using the wine or beverage bottle as the base and stand to support the wine glass holder so that the wine bottle, 4 or more glasses and the glass rack can all be carried by one person using only one hand.

The wine glass and bottle holder has a central hole that fits over the top of the wine bottle, with surrounding slotted receptacles where a stemmed wine glass in an inverted position are stored.

The wine glass and bottle holder may be may any shape such as circular, square or free form with varying sizes and the size and number of receptacle holes can vary according to the type of wine or beverage bottle and the size of the stemmed glasses. The wine glass and bottle holder can be manufactured from a wide range of materials, including but not limited to, wood and wood products, plastic or PVC materials, metal and artificial stone or other materials and can be decorated as desired.

### BACKGROUND OF THE INVENTION

The invention is used a server to transport wine or other bottled beverage and the wine glasses or stemware. The holder/server/coaster is a flat surface of approximately ¼ inch in height and approximately 7 to 9 inches in diameter, that surface can vary in shape. It could be round, square or free form with a hole in the center large enough to accommodate the top a wine or other beverage bottle with 4 or more slots with holes equal distance apart around the outside edges, in order to slide in and hold inverted stemware. The center hole is placed over a wine bottle and the inverted stemware is added to the holder/server and the wine or beverage bottle becomes the base of the glass holder/server/coaster. After the holder/server/coaster, wine and glasses have been transported and served, the empty holder/coaster/server then can be placed on the table to be used as a wine bottle coaster.

The invention is a simple device to be used in home, restaurants or anywhere drinks are served, when serving wine, champagne or any bottled beverage with wine glasses or stemware. The holder/server/coaster makes it possible for one person to carry the wine (or bottled beverage) and wine glasses (or stemware) to a table to serving area using only one hand around the wine or beverage bottle, eliminating the need to make several trips. The invention is primarily used with wines or champagne, but is suitable for almost any bottled beverage to be served with stemware. The invention eliminates the need to separately carry the individual wine glasses and wine or beverage bottle to the serving table separately, as the wine, champagne or beverage bottle becomes the stand and base of the wine glass rack, so that 4 or more wine glasses or stemware and the bottle of wine or other beverage can be carried by one person to the serving area.

The surface of the wine and wine glass holder/server can be decorative as desired and the shape, size and number and size of holes and slots can be varied as needed to accommodate the immediate needs. The size, shape, and number of slots and holes are variable and do not affect the purpose or the function of the invention.

### SUMMARY OF THE INVENTION

The invention is primarily used with wine or champagne, but is suitable for any bottled beverage. The invention is placed in a horizontal position over a full bottle of wine, the hole in the center large enough to clear the seal on the top of a bottle of wine or other beverage. Wine glasses or stemware are hung in an inverted position from surrounding receptacles. Depending on the type of wine, the shape of the glasses and the approximate diameter of the invention, anywhere from 2 to 8 wine glasses can be hung from the holder. The invention eliminates the need to carry each individual wine glass or stemware and beverage to each individual place setting as the wine bottle or beverage bottle and four or more glasses and the glass rack can all be carried by one person using only on hand.

The shape of the wine glass and bottle holder is not critical. For example the holder/server/coaster could be circular, square or a free form decorative shape with any decorations as desired.

The wine glass and bottle holder can be manufactured from a number of materials. These include wood and wood composite materials, plastics and PVC, metals, and any other suitable materials to be shaped and decorated as desired.

### BRIEF DESCRIPTION OF THE DRAWINGS

FIG. 1 Perspective drawing showing the wine bottle and wine glass holder/server/coaster used to carry and present beverages

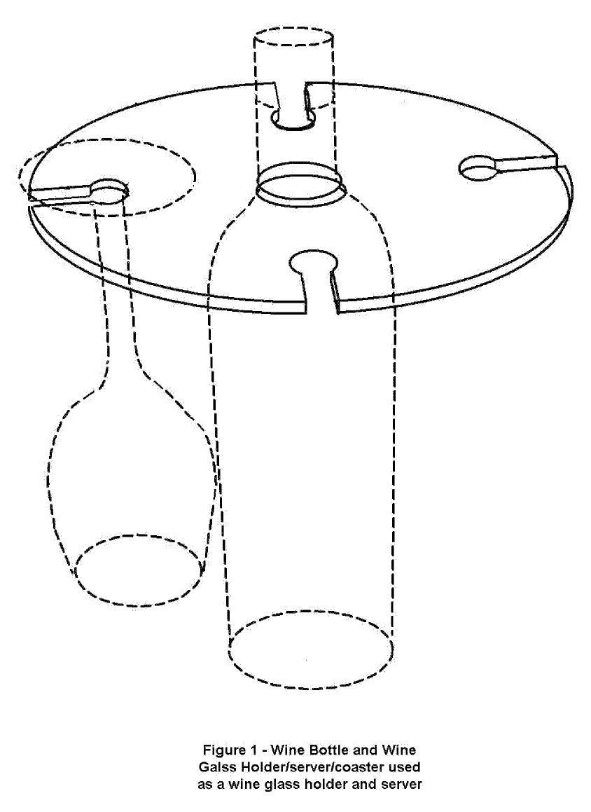

FIG. 2 Perspective drawing showing the wine bottle and wine glass holder/server/coaster used as a bottle coaster to catch drips from bottle

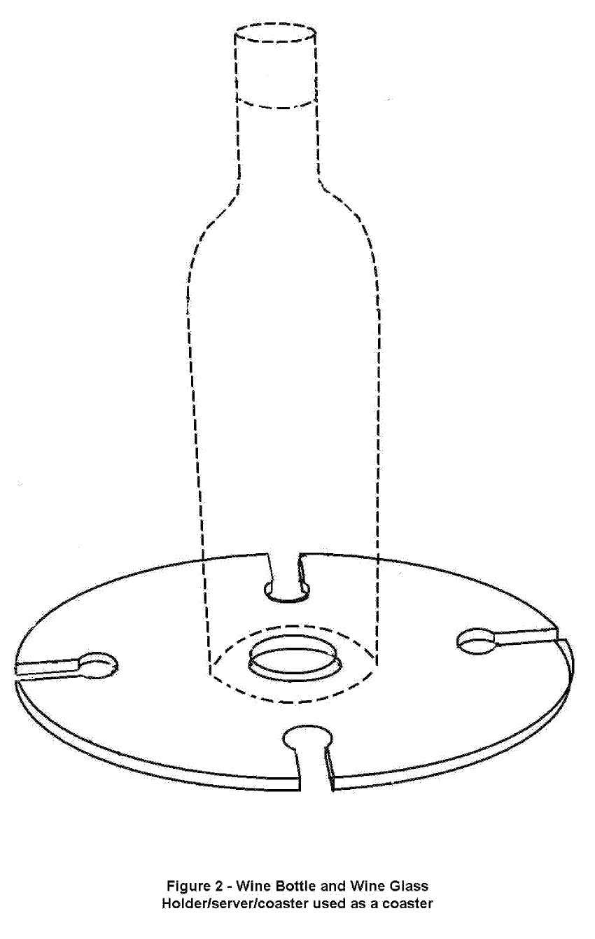

FIG. 3 Plan and section drawings showing a circular wine bottle and wine glass holder/server/coaster with four wine glass receptacles. Note the shape of the wine bottle and wine glass holder/server/coaster is not limited to a circular device and the number of receptacles is not limited to four.

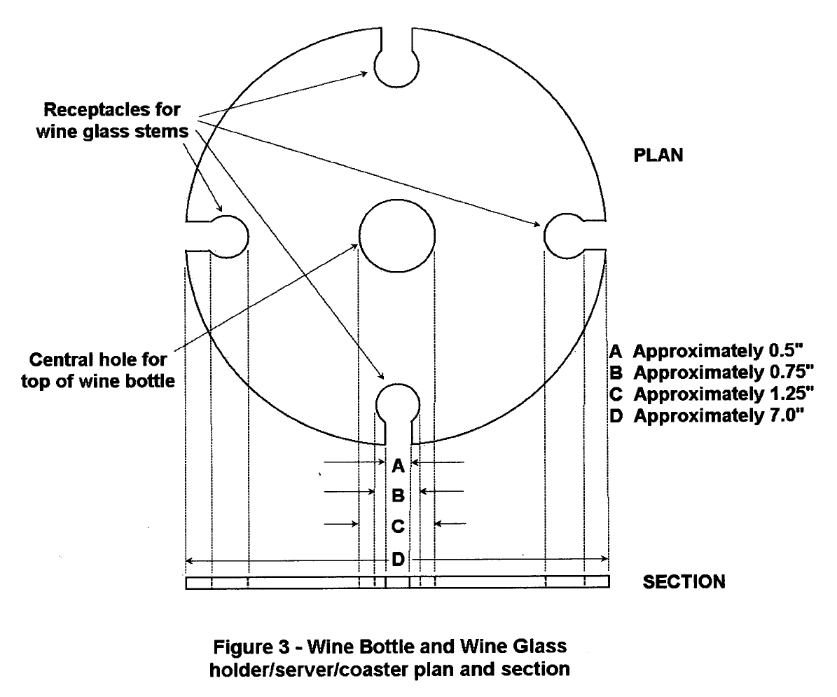

### DETAILED DESCRIPTION OF THE INVENTION

The WINE BOTTLE AND WINE GLASS HOLDER/SERVER/COASTER, is used to serve wine or other bottled beverages and wine glasses or stemware as one simple entity. The central hole in the WB&WGh/s/c is placed over the neck of the wine or beverage bottle. The WB&WGh/s/c is supported from the bottle's shoulders. The WB&WGh/s/c rests on the shoulders in a horizontal position. The size of the WB&WGh/s/c is not critical but it should be approximately 2½ to 3 times the diameter of the beverage bottle.

On the outer rim of the WB&WGh/s/c there are 4 to 8 receptacles, equal distance apart, from which stemmed glassware can be hung in an inverted position. The receptacles are circular in shape, with slightly smaller slots to the outer rim of the “holder”. The slot must be large enough to allow the stem of a glass to easily slide to the larger diameter circular hole. The holes are slightly larger than the slots to hold the base of the stemmed glass securely when carried.

The WB&WGh/s/c is used as a bottle and wine glass carrier using the wine or beverage bottle as the base to support and carry the wine, glasses and WB&WGh/s/c. After pouring the wine or beverage, the WB&WGh/s/c can be used as a coaster under the bottle to prevent drips from coming in contact with the serving surface.

The shape of the WB&WGh/s/c is not critical. In the example shown with this application a circular shape is shown. The shape can be circular, square or free form. The WB&WGh/s/c is a single plate or disc and can be manufactured from any suitable material, wood or wood composites, plastic or PVC materials, metal, or any other suitable product. The method of manufacture would depend on the material used. The WB&WGh/s/c surface can be finished in any suitable artistic design, colors or patterns.

What is claimed is:

1. We claim the wine glass and bottle holder/server/coaster as described is to be used to transport wine or other beverage bottle and 4 or more wine glasses or other stemware by one person holding on to the wine or beverage bottle that is the base or stand.

2. We claim that after serving the wine glass and bottle holder/server/coaster as described then becomes a wine or beverage bottle coaster to prevent red wine or other beverage drips from coming in contact with the table, serving surface or table linens.
